(19) United States
(12) Patent Application Publication
(10) Pub. No.: US 2010/0110881 A1
(43) Pub. Date: May 6, 2010

(54) METHOD FOR PROTECTION SWITCHING IN ETHERNET RING NETWORK

(76) Inventors: Jeong-Dong Ryoo, Daejeon-city (KR); June-Koo Rhee, Daejeon-city (KR); Jin-Sung Im, Ulsan-city (KR); Bheom-Soon Joo, Daejeon-city (KR); Young-Sun Kim, Daejeon-city (KR); Zahir Uddin Ahmad, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/593,955

(22) PCT Filed: Mar. 31, 2008
(86) PCT No.: PCT/KR08/01783

§ 371 Date: Jan. 20, 2010

(30) Foreign Application Priority Data
Mar. 30, 2007 (KR) 10-2007-0031979
Sep. 14, 2007 (KR) 10-2007-0093393
Mar. 28, 2008 (KR) 10-2008-0029267

(51) Int. Cl. G06F 11/00; H04L 12/26

(52) U.S. Cl. 370/225; 370/242

(57) ABSTRACT

Provided is a protection switching method via forwarding table correction in an Ethernet ring network. Upon detecting a failure in a link, a node generates a protection switching frame including an address list of a forwarding table corresponding to a port connected to the link, and transmits the protection switching frame to a port at an opposite direction of the link. A node that receives the protection switching frame deletes its own address from the address list included in the protection switching frame, and changes a port number of an address in the address list of the protection switching frame from among addresses of the forwarding table corresponding to a port that received the protection switching frame to a port number in an opposite direction of the port that received the protection switching frame or deletes the port number of the address in the address list.

### TECHNICAL FIELD

The present invention relates to a protection switching method in an Ethernet ring network, and more particularly, to a protection switching method via transmission table correction of an Ethernet ring node.

The present invention is derived from a research project supported by the Information Technology (IT) Research & Development (R&D) program of the Ministry of Information and Communication (MIC) and the Institute for Information Technology Advancement (IITA) [2005-S-102-03, Carrier Class Ethernet Technology].

### BACKGROUND ART

In order to provide Ethernet ring protection switching, a forwarding table is prepared so that frame forwarding of each Ethernet node does not form an endless loop in an Ethernet ring. Such forwarding table is realized via a link blocking method and an active management method.

According to the link blocking method, a link included in a ring is deactivated so as to logically prevent the ring from forming as if the link does not exist, and endless loop transmission is prevented by preparing a forwarding table of each node by using an address learning method used in a general Ethernet media access control (MAC). Here, a block link is only logically determined, and a physical link of the block link exists. Thus, when such local block link is removed, transmission of traffic is immediately possible.

According to the active management method, a manager or a routing protocol manages contents of the forwarding table of each node, or endless loop transmission is prevented by combining the active management method and the address learning method. The active management method is highly efficient since the optimum path is provided via an effective forwarding table.

When a failure occurs in a conventional Ethernet ring network, a block link is removed if the block link logically exists in a ring, and endless loop transmission of the ring is prevented as a failure link provides a physical or logical block. When several Ethernet rings are combined, a block link of a ring where a failure is not occurred is newly selected so that the whole Ethernet network forms a spanning tree structure without a loop.

When a physical block link due to a failure and a block link for loop prevention are newly selected, a forwarding table is no longer valid, and thus all nodes require new forwarding tables. In order to prepare a new forwarding table, all nodes start a new address learning process. During the address learning process, a node, which received a frame including a destination address (DA) that is not yet learned, broadcasts the frame through all ports. Then, if a source address (SA) of a frame is not learned in the forwarding table, the SA of the frame and a port number that received the frame are recorded in the forwarding table. In other words, forwarding tables are all removed after protection switching, and thus whenever a frame having a new address that is not recorded in the forwarding table as a DA is received, the frame is copied and transmitted towards the both direction of a ring. Accordingly, the larger amount of frames than a normal state is provided in the Ethernet ring network until all SAs are learned.

In other words, since a protection switching technology in a conventional ring network deletes and initiates forwarding table information, a transition phenomenon occurs, where the amount of traffic overshoots after protection switching. In order to prevent a packet loss due to such transmission phenomenon, the link amount of the ring network or the bandwidth of the ring network should be obtained more than necessary, which is inefficient.

When the link amount or the bandwidth of the ring network is limited, a large capacity buffer may be used in order to prevent the packet loss. However in this case, prompt protection switching (protection switching within 50 ms generally required in a real time voice communication centered network) cannot be provided.

### DETAILED DESCRIPTION OF THE INVENTION

### Technical Problem

The present invention provides a protection switching method which solves a problem of an ineffective protection switching technology in an Ethernet ring network, and settles a transition phenomenon where the traffic amount overshoots after protection switching.

The present invention also provides an effective protection switching method which uses a share node in an Ethernet multi-ring network.

### Technical Solution

According to an aspect of the present invention, there is provided a protection switching method of a node connected to a link having a failure in a ring network, the protection switching method including: generating a protection switching frame including an address list of a forwarding table corresponding to a port connected to the link; and transmitting the protection switching frame.

According to another aspect of the present invention, there is provided a protection switching method of a node receiving a protection switching frame in a ring network, the protection switching method including: receiving the protection switching frame; deleting an address of the node from an address list included in the protection switching frame; and correcting a port number of an address included in the address list from among addresses of a forwarding table of the node corresponding to a port that received the protection switching frame to a port number at an opposite direction of the port that received the protection switching frame.

According to another aspect of the present invention, there is provided a protection switching method of a node receiving a protection switching frame in a ring network, the protection switching method including: receiving the protection switching frame; deleting an address of the node from an address list included in the protection switching frame; and deleting a port number of an address included in the address list from among addresses of a forwarding table of the node corresponding to a port that received the protection switching frame to a port number at an opposite direction of the port that received the protection switching frame.

According to another aspect of the present invention, there is provided a protection switching method of a node receiving a protection switching frame in a ring network, the protection switching method including: receiving the protection switching frame; deleting an address of the node from an address list included in the protection switching frame; and deleting an address of the forwarding table of the node corresponding to a port connected to an external network of the ring network, from the address list of the protection switching frame.

According to another aspect of the present invention, there is provided a protection switching method of a node receiving a protection switching frame in a ring network, the protection switching method including: receiving the protection switching frame; deleting an address of the node from an address list included in the protection switching frame; and discarding the protection switching frame when an address no longer exists in the address list.

According to another aspect of the present invention, there is provided a to protection switching method of a share node connected to a share link having a failure in a multi-ring network, the protection switching method including: generating a protection switching frame for each ring; and transmitting the protection switching frame to the each ring, wherein the protection switching frame comprises from among addresses of a forwarding table of the share node: an address corresponding to a port connected to the share link while belonging to a ring that is to transmit the protection switching frame; and an address corresponding to a blocked port in a neighboring ring direction while belonging to a neighboring ring instead of the ring that is to transmit the protection switching frame.

### Advantageous Effects

According to the present invention, quick protection switching is provided in an Ethernet ring network, and an overshoot transition phenomenon that occurs after the protection switching is reduced by using a protection switching frame that does not require large bandwidth and is effective. Also, by reducing a network bandwidth and unnecessary usage of a buffer, resources and expenses can be reduced.

Also, by using a block bridge using first and second share nodes in an Ethernet multi-ring network, protection switching within 50 ms can be effectively provided without a conventional overshoot transition phenomenon.

### DESCRIPTION OF THE DRAWINGS

FIG. 1 is a diagram illustrating a protection switching method in a ring topology using a block link method according to an embodiment of the present invention;

FIG. 2 is a diagram illustrating a protection switching method in a ring topology using an active management method according to an embodiment of the present invention;

FIG. 3 is a diagram illustrating a protection switching method when a one-way direction failure occurs in a ring topology using an active management method according to an embodiment of the present invention;

FIG. 4 is a flowchart illustrating a process of transmitting a protection switching frame according to an embodiment of the present invention;

FIG. 5 is a flowchart illustrating a protection switching process of a node that received a protection switching frame according to an embodiment of the present invention;

FIG. 6 is a flowchart illustrating a method of deleting port assignment of a forwarding table of each node in a protection switching node, according to an embodiment of the present invention;

FIGS. 7 through 12 are diagrams illustrating a protection switching method according to an embodiment of the present invention when an Ethernet ring is formed with an optimized forwarding table that prevents a loop without a block link;

FIG. 13 is a diagram illustrating a protection switching method according to an embodiment of the present invention when one share node exists in an Ethernet multi-ring network;

FIGS. 14 through 15 are diagrams illustrating a protection switching method according to an embodiment of the present invention when two share nodes exist in an Ethernet multi-ring network;

FIGS. 16 through 17 are diagrams illustrating a protection switching method according to an embodiment of the present invention when at least three share node exist in an Ethernet multi-ring network;

FIG. 18 is a flowchart illustrating a method of transmitting a protection switching frame when a failure occurs in an Ethernet multi-ring network according to an embodiment of the present invention; and

FIG. 19 is a flowchart illustrating a protection switching method of a node that received a protection switching frame when a failure occurs in an Ethernet multi-ring network.

### MODE OF THE INVENTION

The present invention will now be described more fully with reference to the accompanying drawings, in which exemplary embodiments of the invention are shown.

An Ethernet ring network is formed of Ethernet nodes. An Ethernet node includes a plurality of Ethernet ports. At least two Ethernet ports of each Ethernet node are connected to a link that is connected to a neighbouring Ethernet node so as to form a ring. Other Ethernet ports are connected to an Ethernet network outside the Ethernet ring network.

The Ethernet ring network may have a physical ring form, or a logical ring form in a predetermined network that is physically connected. A logical ring may be formed of a ring that uses a block link and a ring that does not use a block link. The present invention provides a protection switching method that can be commonly used in both rings.

A protection switching method of an Ethernet ring network according to the present invention will now be described with reference to the accompanying drawings.

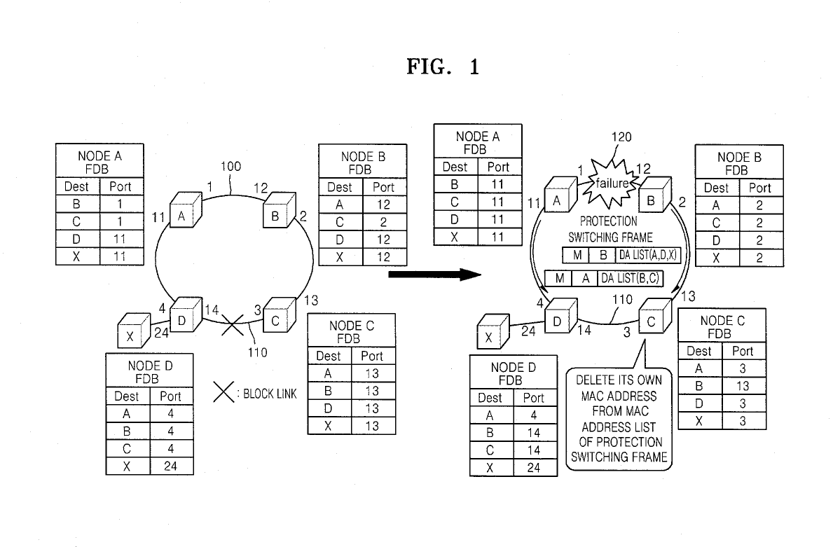

FIG. 1 is a diagram illustrating a protection switching method in a ring topology using a block link method according to an embodiment of the present invention.

According to a method of deactivating a link, a port of any one node from among nodes at both ends of the link may be blocked or all ports of the nodes at the both ends of the link may be blocked.

In FIG. 1, a block link 110 between nodes C and D are logically blocked. In this case, each node of a network 100 is physically connected like a ring, but logically connected in a tree form. Also, each node includes a forwarding table, for example, a filtering database (FDB), and a destination address of a packet is determined by using the forwarding table, i.e. to which port the packet is to be transmitted.

When a failure occurs in a failure link 120 between nodes A and B, the nodes A and B, upon detecting the failure, transmit an automatic protection switching (APS) frame to a link in an opposite direction of the failure link 120. Accordingly, a block of the block link 110 between the nodes C and D is removed, and the block link 110 is activated. At this time, the nodes A and B change a port number of all addresses of a forwarding table corresponding to a port connected to the failure link 120 to a port number connected to the link in the opposite direction of the failure link 120 so that a frame is not transmitted to the failure link 120. Simultaneously, the nodes A and B load an address list of the forwarding table corresponding to the port connected to the failure link 120 on a payload of the protection switching frame. In other words, the node A loads an address list of a forwarding table having a port number connected to the failure link 120, i.e. media access control (MAC) addresses of the nodes B and C, on the payload of the protection switching frame. A structure of the protection switching frame illustrated in FIG. 1 includes a field indicating multicast transmission, a destination address field, and a payload.

A node that received the protection switching frame determines whether its own MAC address is included in the address list loaded on the payload of the protection switching frame, and if the MAC address is included, the MAC address is deleted from the address list. For example, when the node C receives a protection switching frame generated in the node A, the node C deletes its own MAC address C from an address list (B, C) included in the protection switching frame, and then transmits the protection switching frame to the node D.

Also, the node that received the protection switching frame determines whether an address to which a port connected to an external network is assigned exists in the address list of the protection switching frame, and if the address exists, the address is deleted from the address list of the protection switching frame. Also, the node recognizes addresses, to which a port that received the protection switching frame is assigned, from the forwarding table, and changes a port number corresponding to an address in the address list of the protection switching frame from among the recognized addresses to a port number in an opposite direction of the port that received the protection switching frame or deletes the port number corresponding to the address in the address list. After all nodes performed above processes, the corrected forwarding table of each node provides protection switching that transmits a packet without using the failure link 120.

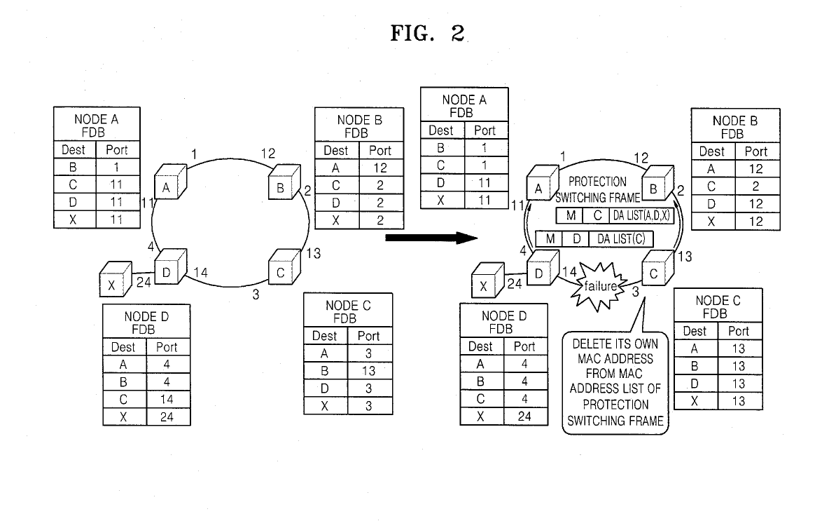

FIG. 2 is a diagram illustrating a protection switching method in a ring topology using an active management method according to an embodiment of the present invention.

Referring to FIG. 2, the active management method uses all links without a block link. When a failure occurs in a link 100 between nodes C and D, the nodes C and D detect the failure. Upon detecting the failure, the nodes C and D recognize an address list, which transmits a packet to a port in a direction where the failure occurred, from a forwarding table, and changes a port number corresponding to an address in the recognized address list to a port number in an opposite direction of the failure so that the packet is transmitted to the opposite direction.

Also, the nodes C and D, upon detecting the failure, each generates a protection switching frame including the address list whose port numbers are changed in the forwarding table, and transmits the protection switching frame to an opposite direction of the port with the failure. In other words, the protection switching frame loads the address list of the forwarding table where the link or the port with the failure is assigned. The nodes C and D multicast the protection switching frame.

Upon receiving the protection switching frame, another node excluding the node that detected the failure updates its own forwarding table by performing the same operation as described in FIG. 1. In other words, the another node deletes its own address and an address assigned to an external port of itself from the address list loaded on the protection switching frame.

A normal node in a non-failure state receives two protection switching frames each generated in two nodes at the both ends of a failure link. If the normal node does not delete its own address or the like from address lists of the protection switching frames, corrections in a forwarding table of the normal node made by the pre-received protection switching frame may be changed again by the post-received protection switching frame. In other words, if the address of the already passed node and an address of an external node connected to the node are left in the address list of the post-received protection switching frame, the corrections in the forwarding table of the node corrected by the pre-received protection switching frame may be changed again by the post-received protection switching frame. In order to prevent such phenomenon, the address of a node that received the protection switching frame and the address of an external node connected to the node should be deleted from the address list loaded on the payload of the protection switching frame.

Also, when an address of a forwarding table to which a port that received the protection switching frame is assigned is included in the address list loaded in the protection switching frame, a port number of such address is changed to a port number in an opposite direction of the port that received the protection switching frame or deleted from the forwarding table.

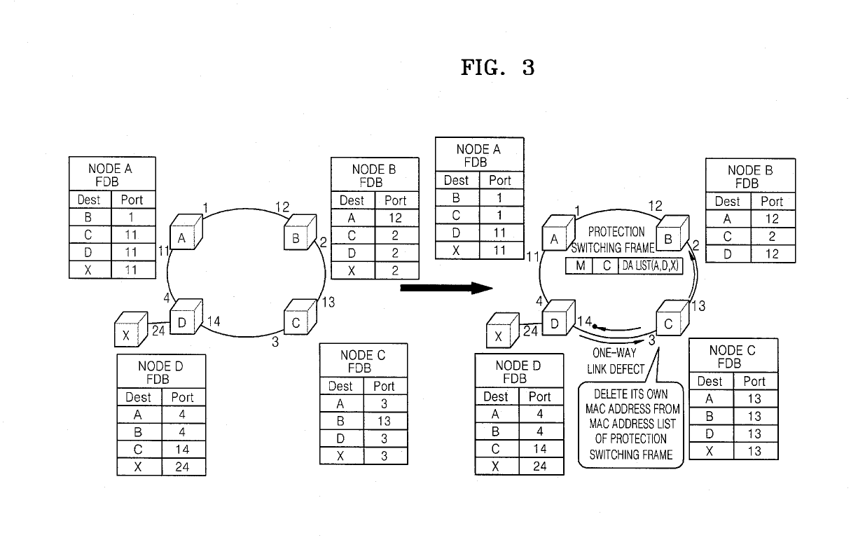

FIG. 3 is a diagram illustrating a protection switching method when a one-way direction failure occurs in a ring topology using an active management method according to an embodiment of the present invention.

Referring to FIG. 3, when a failure occurs in a link from a node C to a node D, the node D cannot receive a continuity check (CC) frame from the node C, and thus transmits a remote defect indication (RDI) frame to the node C. Upon receiving the RDI frame, the node C multicasts a protection switching frame to an opposite direction of receiving the RDI frame. Here, the protection switching frame includes an MAC address list of a forwarding table corresponding to a port that is outputted to the link from the node C to the node D. Operations of a node that received the protection switching frame are equal to those described with reference to FIG. 1, and thus detailed descriptions thereof will be omitted.

When the node C receives the protection switching frame, since a destination address of the protection switching frame and the address of the node C are the same, the protection switching frame is discarded. In this manner, the protection switching frame is transmitted to one direction when the one-way failure occurs so as to perform a protection switching function.

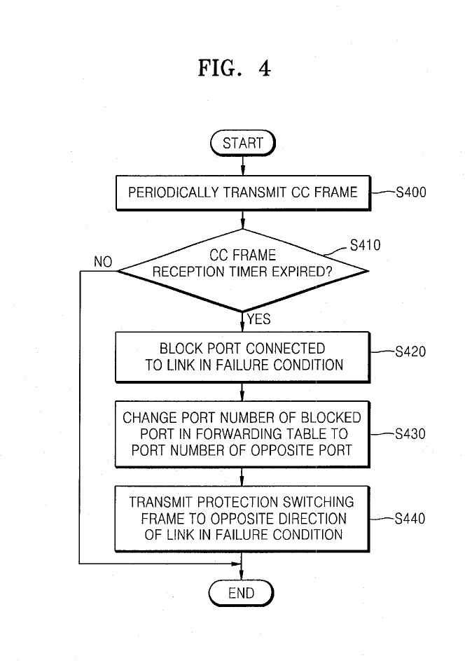

FIG. 4 is a flowchart illustrating a process of transmitting a protection switching frame according to an embodiment of the present invention.

Referring to FIG. 4, nodes located at both ends of a link periodically transceives a CC frame in operation S400. Upon receiving the CC frame, the node initiates a CC frame reception timer. If the CC frame is not received until the CC frame reception timer expires in operation S410, the node determines that a failure occurred in a link that did not receive the CC frame, and blocks a port connected to the link with the failure in operation S420. A port number of addresses of a forwarding table corresponding to the blocked port is changed to a port number in an opposite direction of the link with the failure in operation S430. Then, then node transmits a protection switching frame including an address list of the forwarding table whose port numbers are changed to a link at an opposite direction of the failure in operation S440.

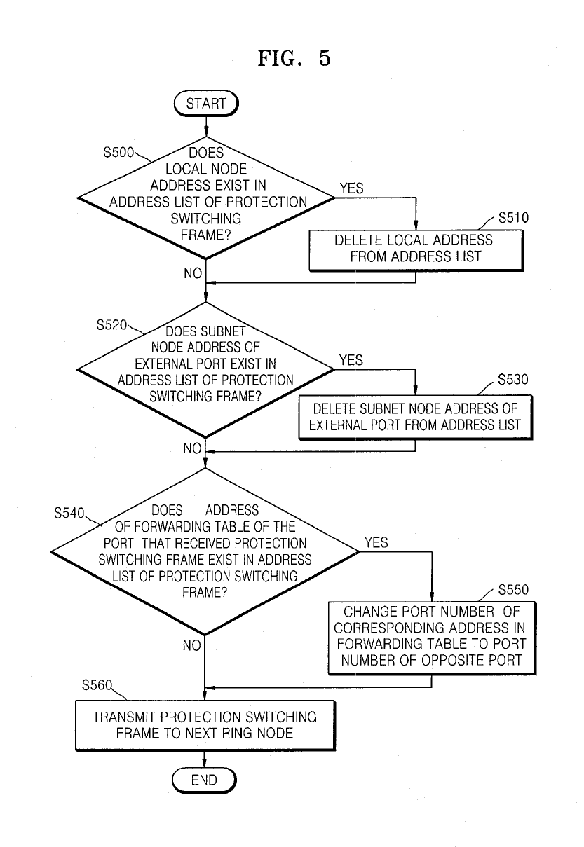

FIG. 5 is a flowchart illustrating a protection switching process of a node that received a protection switching frame according to an embodiment of the present invention.

Referring to FIG. 5, a node of an Ethernet ring that received a protection switching frame generated by a node with a failure determines whether its own MAC address is included in an address list loaded on a payload of the protection switching frame in operation S500. If its own MAC address is included in the address list, the node deletes the MAC address from the address list in operation S510. If an address assigned to a port connected to an external ring in the forwarding table of the node exists in the address list of the protection switching frame in operation S520, the node deletes such address from the address list in operation S530.

After such deleting processes, the node discards the protection switching frame if the address list does not exist in the payload of the protection switching frame. If an address is left in the payload, the node determines whether a same address exists by comparing an address list in its own forwarding table and the address list in the payload in operation S540. If the same address exists, a port number corresponding to the same address in the forwarding table is changed to an opposite port number of a logical ring formed of a virtual local area network (VLAN) in operation S550, and the protection switching frame is transmitted to a next ring node in operation S560. When each node of the Ethernet ring performs the protection switching process, a forwarding table providing a protection switching function is prepared.

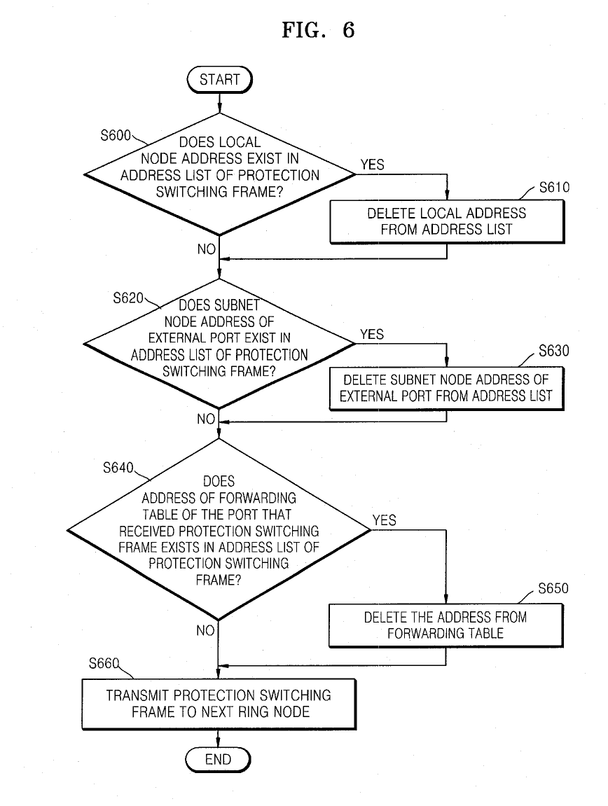

FIG. 6 is a flowchart illustrating a method of deleting port assignment of a forwarding table of each node in a protection switching node, according to an embodiment of the present invention.

Referring to FIG. 6, upon receiving a protection switching frame, a node deletes its own MAC address and an address assigned to an external port from an address list loaded on a payload of the protection switching frame in operations S600, S610, S620, and S630. As operations S600, S610, S620, and 5630 are equal to operations S500, S510, S520, and S530 of FIG. 5, detailed descriptions thereof are omitted herein. After such deleting processes, the node determines whether a same address exists by comparing an address list of a forwarding table and the address list of the protection switching frame in operation S640. Then, the node deletes the same address from the forwarding table in operation S650, and transmits the protection switching frame to a next ring node in operation S660. The method uses a characteristic of broadcasting a frame in a VLAN when a destination address is not in a forwarding table in an Ethernet MAC. According to the method, a protection switching frame can be quickly provided by reducing time consumed in correcting a forwarding table in one node.

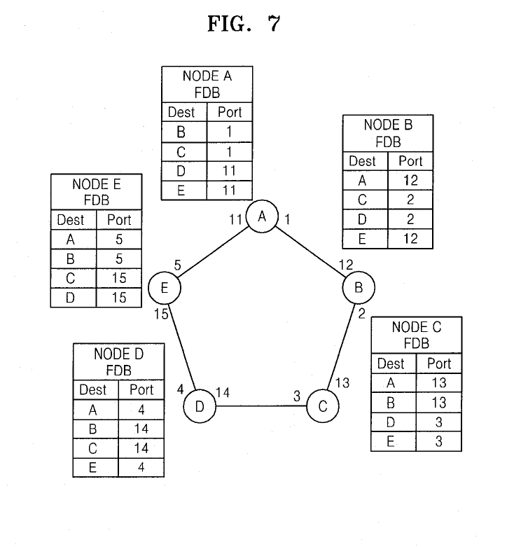

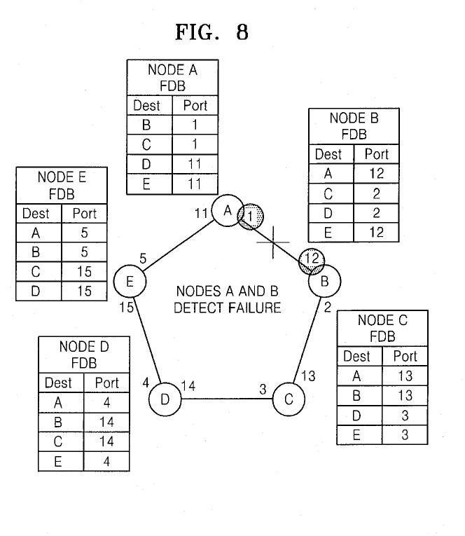

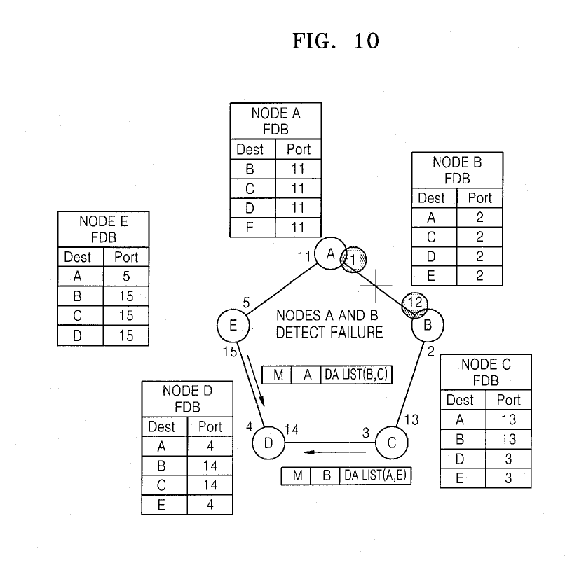

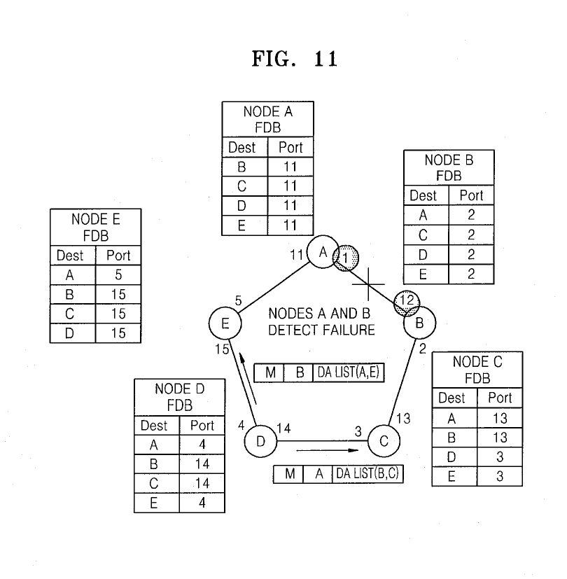

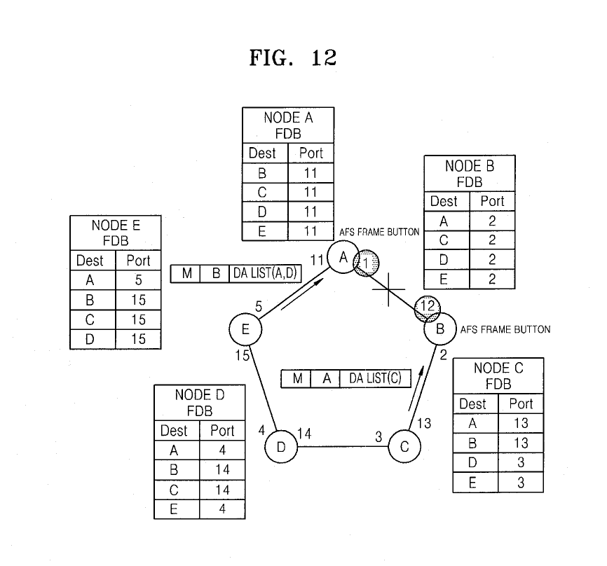

FIGS. 7 through 12 are diagrams illustrating a protection switching method according to an embodiment of the present invention when an Ethernet ring is formed with an optimized forwarding table that prevents a loop without a block link.

Referring to FIGS. 7 through 12, all nodes in the Ethernet ring periodically transceives a CC frame with neighboring nodes. When a failure occurs in a link between nodes A and B, a CC frame reception timer of the nodes A and B expires, and the link between the nodes A and B physically becomes a block link. In this case, the nodes A and B detect the failure in the link, and transmit a protection switching frame to a port at an opposite direction of the failure. Here, MAC address information corresponding to a port 1 of the node A is included in the protection switching frame transmitted by the node A, and MAC address information corresponding to a port 12 of the node B is included in the protection switching frame transmitted by the node B.

Each of nodes C, D, and E receives the protection switching frame, deletes its own MAC address from an MAC address list of the received protection switching frame, and changes an MAC address overlapping with the forwarding table of the port that received the protection switching frame from among the left MAC addresses to a forwarding table of an opposite port of the node. Then, the protection switching frame is transmitted to a next node. When the forwarding tables of all nodes that received the protection switching frame are changed, a protection switching function is provided, and remaining links excluding the link with the failure are used.

In the above, a protection switching method in a single Ethernet ring network is described. Hereinafter, a protection switching method in an Ethernet multi-ring network, wherein at least one ring is overlapped, is described.

Multi-rings are connected by at least one share node and a share link between share nodes. Each ring includes at least one block port or a block link so as to prevent an endless loop from occurring. When a failure occurs in the share link and the block port or the lock link is removed, one big ring wherein two rings are combined is formed, and thus any one bridge that connects the two rings from the bridges of the share nodes should be blocked so as to prevent an endless loop in the big ring.

In order to classify each ring in the Ethernet multi-ring network, a VLAN identification (ID) is assigned to each ring. Accordingly, each node can determine whether a ring exists in the same ring or a different ring in the multi-ring network based on the VLAN ID included in a header of a received packet. Specifically, a VLAN ID field is included in a forwarding table of the share node. Alternatively, when the multi-ring network is a general network, each ring is classified by a virtual private network (VPN) assigned number. When the multi-ring network is a label switching network, each ring may be classified by a multicast label. In addition, based on a type of the multi-ring network, various identifications may be used according to the corresponding type.

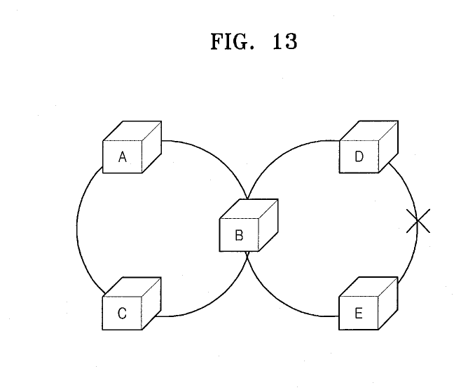

FIG. 13 is a diagram illustrating a protection switching method according to an embodiment of the present invention when one share node exists in an Ethernet multi-ring network.

Referring to FIG. 13, the multi-ring network includes one share node, and does not have a share link. In order to prevent an endless loop, each ring of the multi-ring network includes a block port or a block link. Accordingly, in a standpoint of one ring, another ring is an external network of the share node. Thus in case of the multi-ring network including one share node, the protection switching method described with reference to FIGS. 1 through 12 can be applied.

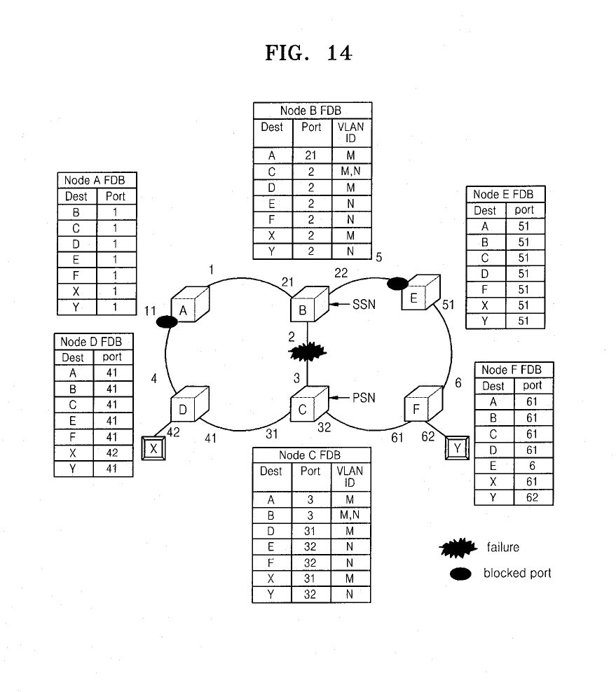

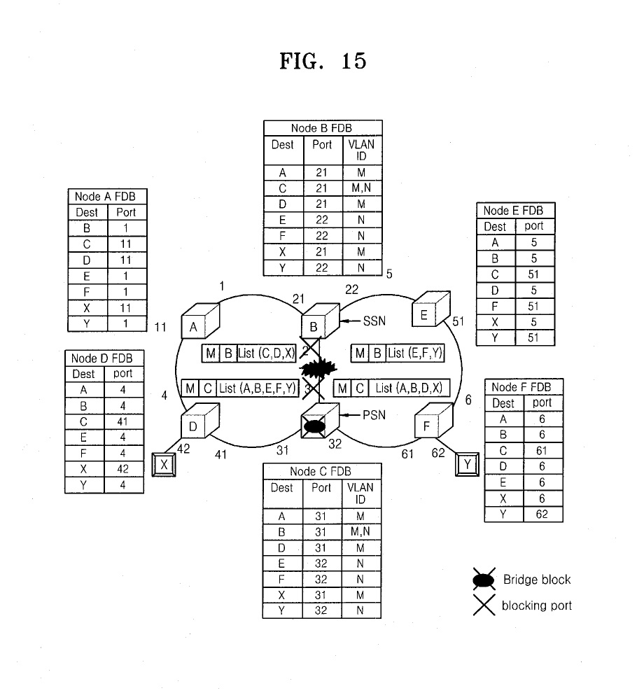

FIGS. 14 through 15 are diagrams illustrating a protection switching method according to an embodiment of the present invention when two share nodes exist in an Ethernet multi-ring network. FIG. 14 illustrates a forwarding table of each node before protection switching and FIG. 15 illustrates a forwarding table of each node after the protection switching.

Referring to FIGS. 14 and 15, each of two rings includes four nodes, where two nodes B and C are share nodes that connect the two rings. In other words, a first ring network is formed of nodes A, B, C, and D, and a second ring network is formed of nodes B, C, E, and F. A node X is a subordinate network of the first ring network, and a node Y is a subordinate network of the second ring network. A subordinate network may be another ring network like FIG. 13. Hereinafter, it is assumed that a port 11 of the node A and a port 5 of the port E are assigned as block ports for preventing loop occurrence, and the forwarding table of each node is generated via a conventional MAC learning process. Also, M is assigned as a VLAN ID in the first ring network, and N is assigned as a VLAN ID in the second ring network.

When a failure occurs in a share link between the share nodes B and C, the share nodes B and C respectively block ports 2 and 3 connected to the share link, and the nodes A and E removes a previous block port. Accordingly, since two rings form one big ring, the share nodes B or C should block a bridge that connects the two rings so as to prevent the loop occurrence. In the current embodiment, the share node C blocks the bridge.

The share nodes B and C each transmit a protection switching frame to a ring. The share nodes B and C each generate the protection switching frame including an address corresponding to a blocked port number from among addresses of the forwarding table of a ring that receives the protection switching frame from a share node, and an address corresponding to a blocked port number in a neighboring ring from among addresses of a forwarding table of the neighboring ring instead of the ring that receives the protection switching frame from a share node.

For example, when the protection switching frame is transmitted to the first ring network, the share node B recognizes destination addresses A, C, D, and X of the nodes of the first ring network from the forwarding table based on the VLAN ID (M), generates the protection switching frame including the addresses C, D, and X having the blocked port 2, and transmits the protection switching frame to the first ring network. The protection switching frame is generated in the same manner when the share node B transmits the protection switching frame to the second ring network.

Alternatively, when the share node C that includes a bridge block transmits a protection switching frame to the first ring network, the share node B recognizes addresses A, B, D, and X of the nodes of the first ring network from the forwarding table based on the VLAN ID (M), and recognizes the addresses A and B including the blocked port 3 in the first ring network. The share node C recognizes addresses B, E, F, and Y of nodes of the second ring network from the forwarding table based on the VLAN ID (N), and recognizes the addresses E, F, and Y including the blocked port 32 in the second ring network whose bridge is blocked. Then, the share node C transmits the protection switching frame including the recognized addresses A, B, E, F, and Y to the first ring network. The share node C generates the protection switching node in the same manner even when the protection switching frame is to be transmitted to the second ring network.

The share nodes B and C each change a blocked port number in the forwarding table to a port number in an opposite direction of the failure. The share nodes B and C include two ports in an opposite direction of the share link, i.e. one port each that faces each ring. Accordingly, the share nodes B and C recognize to which ring an address, whose port number is to be changed in the forwarding table, belongs, and change the address to the a port number of the corresponding ring.

For example, the share node B changes a port number of the addresses C, D, and X having the block port 2 from among the addresses A, C, D, and X that belongs to the first ring network whose VLAN ID is M in the forwarding table to a port 21 in the opposite direction. Also, the share node B changes a port number of the addresses E, F, and Y having the block port 2 from among the addresses C, E, F, and Y that belongs to the second ring network whose VLAN ID is N to a port 22. Here, since the port number of the address C is already changed, it is not required to be changed again. However, the port number of the address C may be changed again. The forwarding table of the share node C is updated according to the same manner.

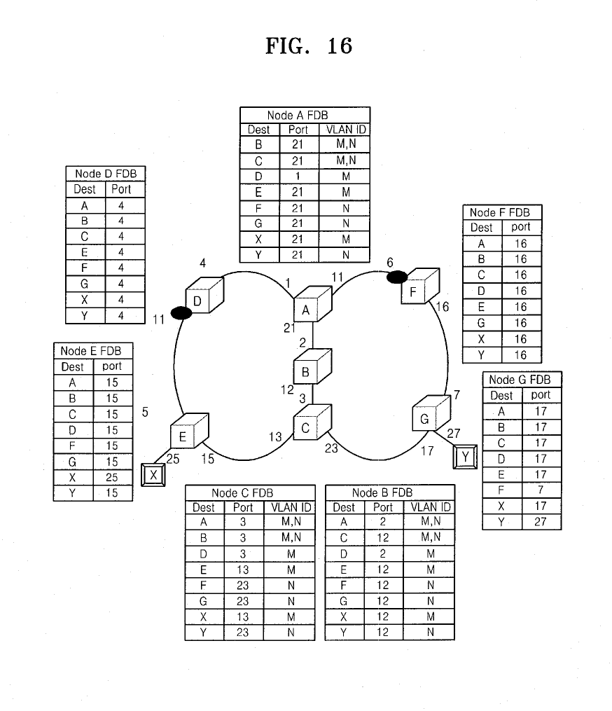

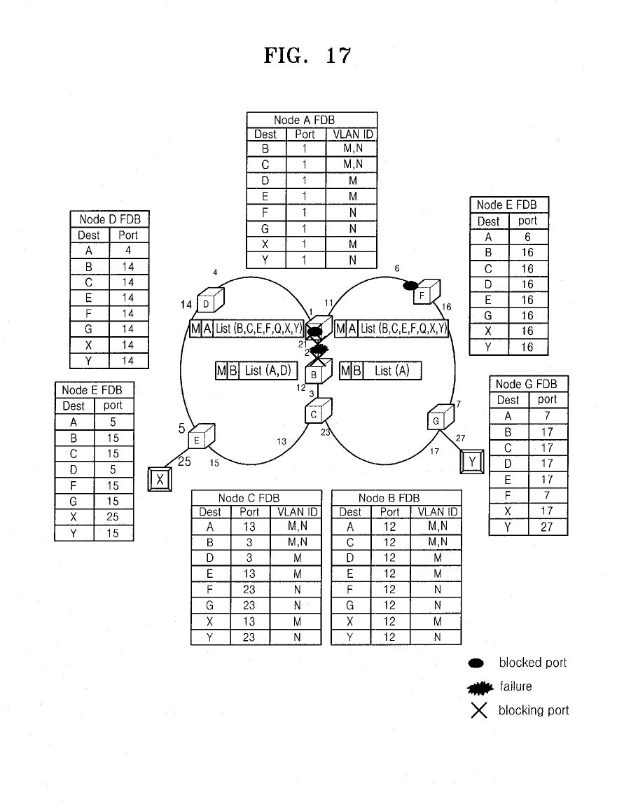

FIGS. 16 through 17 are diagrams illustrating a protection switching method according to an embodiment of the present invention when at least three share node exist in an Ethernet multi-ring network. FIG. 16 illustrates a forwarding table before protection switching and FIG. 17 illustrates a forwarding table after the protection switching.

Referring to FIGS. 16 and 17, the multi-ring network includes three share nodes A, B, and C, and two share links between the share nodes A and B and the share nodes B and C. A node X is a subordinate network of a first ring network and a node Y is a subordinate network of a second ring network. It is assumed that a port 14 of a node D and a port 6 of a node F are assigned as a block port for preventing loop occurrence, and a forwarding table of each node is generated via a conventional MAC learning process. Also, M is assigned as a VLAN ID in the first ring network, and N is assigned as a VLAN ID in the second ring network.

When a failure occurs in the share link between the share nodes A and B, the share node A, upon detecting the failure, assigns a port 21 as a block port, and a bridge connecting two rings as a block bridge. Also, the share node B, upon detecting the failure, blocks a port 2. The share nodes A and B generates and transmits a protection switching frame in the same manner as described with reference to FIGS. 14 and 15. The share node B inserts the VLAN ID in a header of the protection switching frame so that the protection switching frame is transmitted only within one ring. If a failure occurs in the share link between the share nodes B and C, the share node A cannot detect the failure, and thus the share node C generates a block bridge.

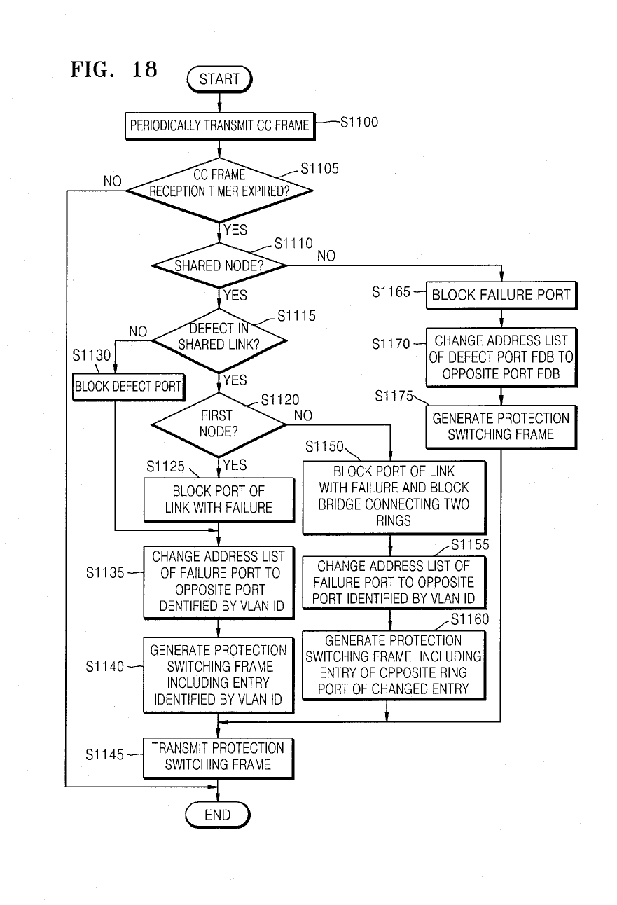

FIG. 18 is a flowchart illustrating a method of transmitting a protection switching frame when a failure occurs in an Ethernet multi-ring network according to an embodiment of the present invention.

Referring to FIG. 18, all nodes periodically transmit a CC frame in operation S1100, and if the CC frame is not received within a predetermined time i.e. when a CC frame reception timer expires in operation S1105, it is assumed that a failure occurred in a link.

In operation S1110, it is determined whether a node that detected the failure is a share node or a general node in the multi-ring network. If the node that detected the failure is a general node, the node blocks a port connected to the link having the failure in operation S1165, changes a port number of the blocked port to a port number in an opposite direction of the failure in a forwarding table in operation S1170, generates a protection switching frame including addresses of the forwarding table whose port number is changed in operation S1175, and transmits the protection switching frame to the port in the opposite direction of the failure in operation S1145.

If it is determined that the node that detected the failure is a share node in operation S1110, the node determines whether the defected link is a share link or a general link in operation S1115. If the defected link is the general link, the share node blocks a port in a direction of the defected link in operation S1130, changes a port number of addresses corresponding to the blocked port to a port number in the opposite direction of the failure in the forwarding table in operation S1135, generates a protection switching frame including an address list of the addresses whose port number is changed in operation S1140, and transmits the protection switching frame to the port in the opposite direction of the failure in operation S1145. Since the protection switching frame includes a VLAN ID indicating each ring in the multi-ring network, the protection switching frame is transmitted within only one ring.

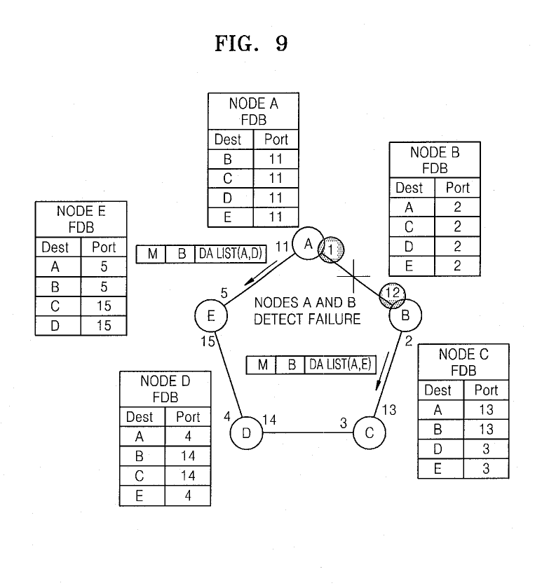

If it is determined that the node that detected the failure is the share node in operation S1110 and that the defected link is a share link in operation S1115, the share node blocks a bridge connecting two rings in operation S1150 so as to prevent a loop phenomenon in one big ring network formed by two connected ring networks. When two share nodes exist as in FIG. 9A, a bridge of only one share node may be blocked. Then, the share node changes a port number of addresses corresponding to the blocked port to a port number in the opposite direction of the failure in the forwarding m table including the VLAN ID in operation S1155, generates a protection switching frame for each ring in operation S1160, and transmits the protection switching frame to the port in the opposite direction of the failure in operation S1145. The updating of the forwarding table of the share node and the generating of the protection switching frame have been described above with reference to FIGS. 9A and 9B.

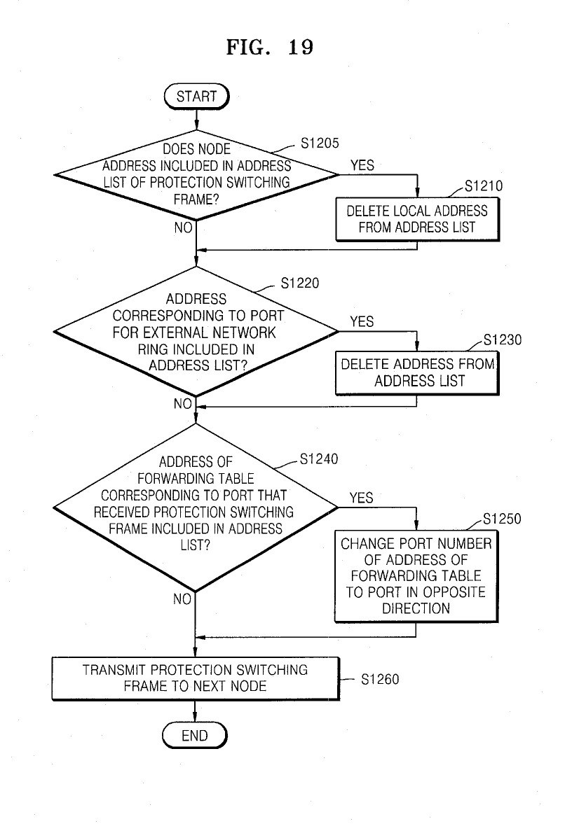

FIG. 19 is a flowchart illustrating a protection switching method of a node that received a protection switching frame when a failure occurs in an Ethernet multi-ring network.

Referring to FIG. 19, when a general node, instead of a share node, receives a protection switching frame in the multi-ring network, the general node compares its own address with an address list included in a pay load of the protection switching frame in operation S1205. If its own address is included in the address list, the general node deletes its own address from the address list in operation S1210. Then, when it is determined that an address of a forwarding table assigned to a port facing towards a subordinate network is included in the address list of the protection switching frame in operation S1220, the general node deletes the address of the forwarding table assigned to the port facing towards the subordinate network from the address list in operation S1230. For example in FIG. 14, if an address of a forwarding table assigned with a port connected to the subordinate network X is included in the address list of the protection switching frame, the address is deleted from the address list.

Then, if it is determined that an address of the forwarding table corresponding to a port that received the protection switching frame is included in the address list in operation S1240, the general node changes a port number of the address to a port number in an opposite direction of the port that received the protection switching frame in operation S1250. Then, the general node multicasts the protection switching frame to a next ring node in operation S1260.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A protection switching method of a node connected to a link having a failure in a ring network, the protection switching method comprising:
generating a protection switching frame including an address list of a forwarding table corresponding to a port connected to the link; and
transmitting the protection switching frame.

2. The protection switching method of claim 1, wherein the transmitting comprises transmitting the protection switching frame to a port at an opposite direction of the link.

3. The protection switching method of claim 1, further comprising correcting a port number of addresses of the forwarding table corresponding to the port connected to the link to a port number at the opposite direction of the link.

4. The protection switching method of claim 1, wherein the detecting of the failure comprises:
periodically transceiving a continuity check frame with neighboring nodes;
initiating a timer when the continuity check frame is received; and
detecting a failure of a link that receives the continuity check frame, when the continuity check frame is not received until the timer expires.

5. A protection switching method of a node receiving a protection switching frame in a ring network, the protection switching method comprising:
receiving the protection switching frame;
deleting an address of the node from an address list included in the protection switching frame; and
correcting a port number of an address included in the address list from among addresses of a forwarding table of the node corresponding to a port that received the protection switching frame to a port number at an opposite direction of the port that received the protection switching frame.

6. The protection switching method of claim 5, further comprising deleting an address of the forwarding table of the node corresponding to a port connected to an external network of the ring network, from the address list of the protection switching frame.

7. The protection switching method of claim 5, further comprising discarding the protection switching frame when an address no longer exists in the address list.

8. A protection switching method of a node receiving a protection switching frame in a ring network, the protection switching method comprising:
receiving the protection switching frame;
deleting an address of the node from an address list included in the protection switching frame; and
deleting a port number of an address included in the address list from among addresses of a forwarding table of the node corresponding to a port that received the protection switching frame to a port number at an opposite direction of the port that received the protection switching frame.

9. A protection switching method of a node receiving a protection switching frame in a ring network, the protection switching method comprising:
receiving the protection switching frame;
deleting an address of the node from an address list included in the protection switching frame; and
deleting an address of the forwarding table of the node corresponding to a port connected to an external network of the ring network, from the address list of the protection switching frame.

10. A protection switching method of a node receiving a protection switching frame in a ring network, the protection switching method comprising:
receiving the protection switching frame;
deleting an address of the node from an address list included in the protection switching frame; and
discarding the protection switching frame when an address no longer exists in the address list.

11. A protection switching method of a share node connected to a share link having a failure in a multi-ring network, the protection switching method comprising:
generating a protection switching frame for each ring; and
transmitting the protection switching frame to the each ring,
wherein the protection switching frame comprises from among addresses of a forwarding table of the share node:
an address corresponding to a port connected to the share link while belonging to a ring that is to transmit the protection switching frame; and
an address corresponding to a blocked port in a neighboring ring direction while belonging to a neighboring ring instead of the ring that is to transmit the protection switching frame.

12. The protection switching method of claim 11, wherein the transmitting comprises transmitting the protection switching frame to the each ring via a port that exists at opposite direction of the share link.

13. The protection switching method of claim 11, further comprising the share node blocking a bridge connecting two rings.

14. The protection switching method of claim 9, further comprising the share node recognizing addresses of the forwarding table corresponding to the port connected to the share link, and changing a port number of the recognized addresses to a port number of a ring to which the recognized addresses belong from among port numbers connected to each ring and existing in an opposite direction of the share link.

15. The protection switching method of claim 11, wherein, when the multi-ring network is an Ethernet, each ring is classified by a virtual local area network (VLAN) identification (ID).

16. The protection switching method of claim 11, wherein each ring is classified by a virtual private network (VPN) assigned number in the multi-ring network.

17. The protection switching method of claim 11, wherein, when the multi-ring network is a label switching network, each ring is classified by a multicast label.
